(19) United States
(12) Patent Application Publication
(10) Pub. No.: US 2002/0156715 A1
(43) Pub. Date: Oct. 24, 2002

(54) Apparatus and method for auctioning and reissuing a ticket online

(76) Inventors: Cameron Wall, Solon, OH (US); Stephen Hayne, Fort Collins, CO (US); Michael Benedict, Solon, OH (US)

Correspondence Address: Todd R. Tucker, Renner, Otto, Boisselle & Sklar L.L.P., Nineteenth Floor, 1621 Euclid Avenue, Cleveland, OH, 44115, US

(21) Appl. No.: 09/837,931

(22) Filed: Apr. 19, 2001

(51) Int. Cl. G06F 17/60

(52) U.S. Cl. 705/37; 705/5

(57) ABSTRACT

A system for auctioning, canceling and reissuing a ticket having an auction server in communication with an auction engine which in turn communicates with a barcode canceler/issuer for issuing a new ticket. The system also includes an auction database in communication with the auction engine. The auction database is capable of receiving and transmitting ticket information to the auction engine and ultimately back to a venue system for canceling and issuing a new ticket.

### FIELD OF INVENTION

This invention relates to an apparatus and method for an online ticket auction, cancellation of a ticket's bar code and reissuance of a ticket to the winning bid or at an instant sales price.

### BACKGROUND OF INVENTION

Holders of tickets for many different types of events are often unable to use their tickets for all of the individual events that occur during a season. This is especially true for ticket holders who own season tickets for sports that have long seasons with many games, like major league baseball. Oftentimes, over the course of a long season, a season ticket holder or even a ticket holder of an individual event will be unable to attend a game for which he/she holds a ticket. In such an instance, it can be very difficult for this ticket holder to sell tickets he/she cannot use. Often, these tickets simply go unused.

Corporations that own season tickets encounter these problems as well as other complications relating to selling season tickets that would otherwise remain unused. These corporations often own blocks of tickets and/or luxury suites for corporate entertainment. Like individual ticket holders, corporations also sometimes are unable to use their tickets. Corporations may have a particularly difficult time selling their tickets due to constraints such as the large block size of their tickets, and they may only want to sell premium box seats and/or suite tickets to other corporate entities. Thus, very limited opportunities exist for corporations to sell their season tickets to individual games.

Another problem associated with tickets to entertainment events is the practice of scalping tickets. When an event is sold out, ticket scalpers often sell tickets outside the immediate vicinity of the venue. In instances where such sales occur, the tickets usually sell for far more than the ticket's original price. In fact, when scalpers sell tickets, the sales price may be many times in excess of the original ticket's face value.

Also, when purchasing tickets from a scalper, the potential ticket buyer's choices are limited to the physical tickets the scalper has on hand. For instance, if a ticket buyer desires bleacher seats, but the scalper only has box seat tickets, the ticket buyer faces the dilemma of purchasing the more expensive box seat ticket or not purchasing any tickets at all. Furthermore, in many jurisdictions, scalping is illegal or, at least, regulated so the ticket buyer may be engaging in an illegal act when purchasing “scalped” tickets.

In order to address some of these problems, ticket holders have tried to sell tickets on stand-alone internet auction sites such as ebay.com. On these standard auction sites, the ticket holder can put his/her tickets up for sale and let interested buyers bid on them. The winning bid then is allowed to purchase the tickets. Many problems exist for this type of ticket sale. First, in order to consummate this type of auction, the ticket holder must somehow deliver the physical tickets to the winning bidder. Only with the physical tickets will the winning bidder be admitted to the venue. Thus, various logistical and escrow related problems are associated with obtaining a physical ticket and these problems only increase as the start time for the event draws nearer.

Another problem that exists with current online auctions and scalpers is counterfeit tickets. When someone bids on tickets online or buys tickets from a scalper, he/she cannot be completely assured that the ticket bid on is valid. To combat counterfeiting, many venues place barcodes on tickets so that an electronic ticket reader at the gate may confirm validity. Often, counterfeit tickets will have a false bar code imprinted on them to give the appearance that they are genuine. However, these false bar codes will not be read properly by the venue's barcode system so admittance will be denied for holders of counterfeit tickets. Many times, unscrupulous scalpers have sold counterfeit tickets to an unsuspecting buyer who only finds out the ticket is counterfeit when he/she is refused admittance to the venue. Thus, the buyer is bilked out of his/her money while denied entrance to the event. Additionally, the buyer faces the public embarrassment of being denied admission and may suffer the further aggravation of detainment for attempting to use a counterfeit ticket.

In view of the aforementioned shortcomings, there exists a strong need in the art for an online reissue ticket auction system which provides a manner for ticket holders to sell tickets that would otherwise go unused while eliminating the problems associated with current auctions. At the same time, there is a strong need for a system to ensure that the buyer of these reissued tickets purchases valid, non-counterfeit tickets.

### SUMMARY OF THE INVENTION

There remains a need for a ticket holder who cannot attend the event for which they hold tickets to be able to easily sell the ticket so that it does not go unused. Furthermore, there remains a need for a ticket to be auctioned and reissued electronically to facilitate ease of delivery to the winning bidder or instant sales buyer while ensuring the authenticity of the ticket. It would also be desirable if the secondary ticket buyer pays for the ticket electronically to speed up the transaction, guaranteeing that the original ticket holder will be properly paid for the ticket reissued to the auction winner or instant sales price purchaser.

In accordance with one aspect of the present invention, there is provided an apparatus for conducting an online auction for tickets to any type of event. In one embodiment, the ticket holder is permitted to set various parameters of the auction including the number of tickets for sale. The auctioneer may also set these parameters, as well as minimum bid price, instant sales price, minimum bid increment and auction start and conclusion points. Also, the auction includes features such as immediate notification, e.g. email, to auction winners or instant sales price buyers. The original ticket holder is also immediately notified, both when an initial valid bid is placed on previously released tickets and when the ticket sale is eventually consummated, either at the auction closing or when a sale is finalized at the instant sales price. Finally, once the auction is won, the winner's online account is immediately charged the price of the tickets. The auction's system immediately issues the ticket electronically to the auction winner if that was the delivery method chosen.

The invention further provides bar code cancellation and reissue features which allow the ticket to be sold via the online auction and transferred to the auction winner without physically exchanging the ticket. Instead, once the tickets are released by the season ticket holder to an auction server of the present invention, the barcode on the ticket holder's ticket is canceled so that the original ticket is no longer valid. The winner of the auction is then issued a new ticket with a new bar code. In one embodiment, the winner must simply print out a hard copy of the new barcode which now represents the valid ticket for the venue. The entire transaction occurs electronically so that no physical ticket has to exchange hands.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is a system diagram illustrating an embodiment of the present invention;

FIG. 2 is a block diagram illustrating the database of the present invention;

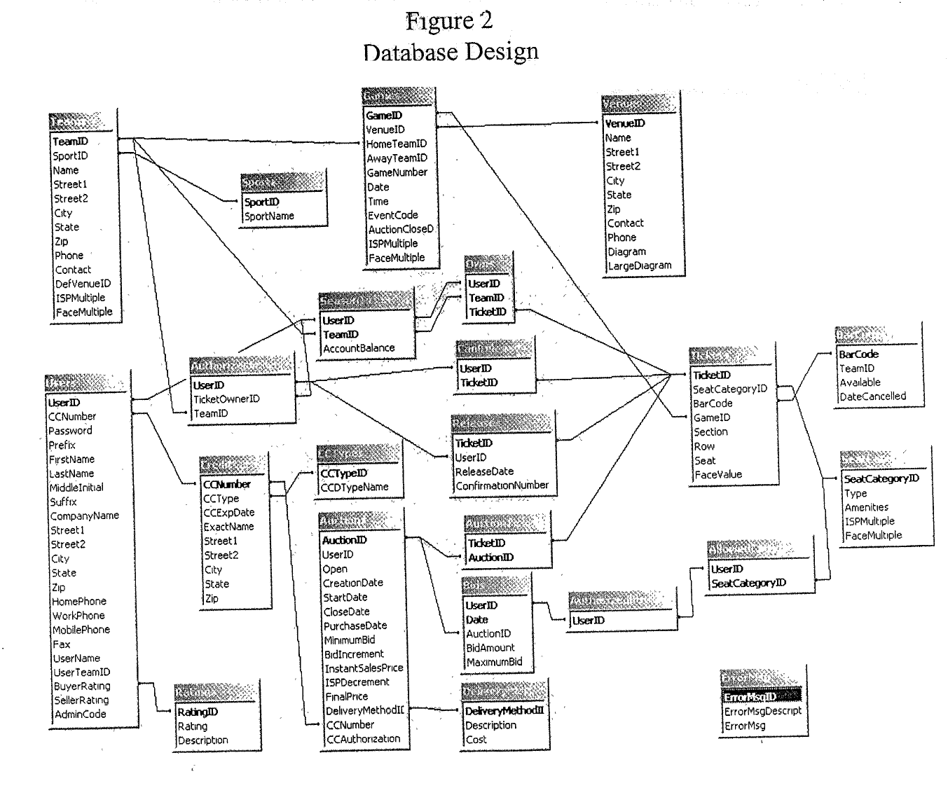

FIG. 3 is a block diagram of the login features of the present invention;

FIG. 4 is a block diagram illustrating the release feature of the present invention;

FIG. 5 is a block diagram illustrating the search auction logic feature of the present invention;

FIG. 6 is a block diagram illustrating the auction logic and instant sales price function of the present invention;

FIG. 7 is a block diagram illustrating the auction logic decrement function of the present invention; and

FIG. 8 is a block diagram illustrating the auto extend function of the auction features of the present invention.

### DETAILED DESCRIPTION

The present invention will now be described with reference to the drawings, wherein like reference numerals are used to refer to like elements throughout.

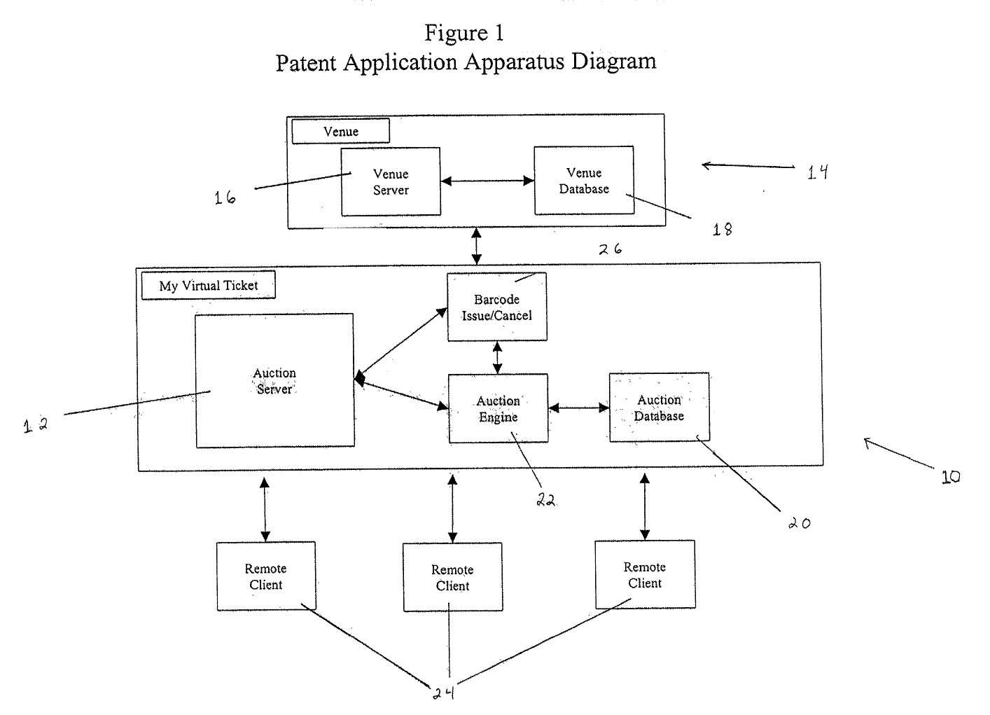

Referring now to the drawings, FIG. 1 illustrates a block diagram of the exemplary system of the present invention. The online ticket auction and reissuance system 10 includes an auction server 12 having memory and a processor and capable of synchronous communication with a venue system 14 and remote clients 24. The auction server 12 communicates with a server 16 of the venue system 14 in order to access a venue database 18 and transmit and receive ticket information. In an exemplary embodiment, the venue database 18 contains at least data fields for the ticket information for the particular venue and communicates with the venue server 16. The venue database 18 is able to communicate with the auction server 12 through the venue server 16.

Specifically, the venue database 18 is ultimately able to transmit to the auction server 12 all relevant venue information such as the entire seat-by-seat bar code identification scheme. In the exemplary embodiment, as transmission of the venue database information occurs, the auction server 12 automatically forwards it to the auction database 20 using conventional methods.

The auction database 20 includes a number of data fields necessary to conduct the auction and issue new tickets, among other things. These data fields may include, but are not limited to, the schedule of events for the venue, the entire seat-by-seat bar code identification coding scheme for all the seats in the venue, the bidder's information, such as identification and credit card information and auction information including open date, minimum bid, increment, final sales price and instant sales price. All relevant information pertaining to the season ticket holders, such as account information, demographic and other designated information will also be included in the auction database. The auction database 20 may also contain relevant data fields necessary to conduct an online transaction as are well known in the art.

In the exemplary embodiment, the auction database 20 is able to communicate with an auction engine 22 that will be described in more detail below. The auction engine 22 allows the original ticket holder (or their proxy, hereafter referred to as the original ticket holder) to initiate an auction via a remote client 24, i.e. personal computer capable of accessing the world-wide-web, while also permitting the auction to actually occur once this original ticket holder has released tickets for reissue. Finally, both the auction database 20 and the auction engine 22 are in communication with the barcode canceler/issuer 26. Upon release of a ticket for auction, the canceler/issuer 26 cancels the barcode on the original ticket and once the auction is completed, issues a new barcode to the winning bidder. A new barcode is also issued for released tickets purchased at the instant sales price when that transaction is authorized and consummated.

The auction database 20 contains information provided by the venue system 14, i.e. the barcode for every seat in the venue for each event in the specified team's season as well as demographic information about the season ticket holder. When tickets are released for auction, the barcode information for that group of released tickets is invalidated in the auction database 20 by the barcode canceler 26. The auction database 20 then communicates this cancellation to the venue database 18 via the respective servers 12, 16.

When tickets are purchased, the barcode canceler/issuer 26 then acts to create new barcodes for admission to the event purchased in the seats purchased. The auction database 20 maintains groups of unused barcodes for a particular venue. When a bidder wins an auction, the barcode canceler/issuer 26 pulls a group of unused barcodes for the venue selected. The barcode canceler/issuer 26 then communicates these new barcodes to the winning bidder as well as the auction database 20 and the venue database 18. Both databases 18, 20 update the necessary information to show that the new barcodes are now the authorized barcodes to allow admission to the event purchased for the seats purchased.

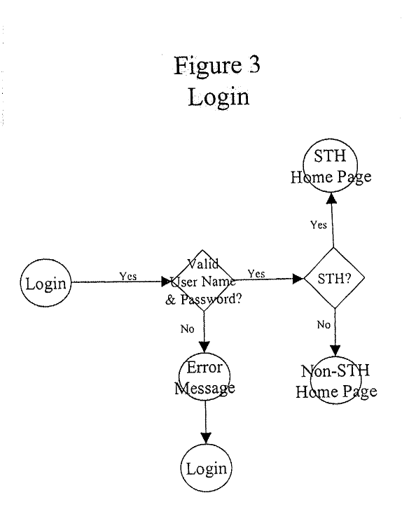

The online auction of the present invention is initiated by the login procedure illustrated in FIG. 3. To initiate the system, the user, who can be either an original ticket holder preparing to auction tickets or a bidder preparing to bid on tickets, must login to the auction system 10 using a remote client device 24 such as a personal computer or other web browser. The login procedure is well known in the art and requires a valid userID as well as a valid password. The user identification and the corresponding password are stored in the auction database. Once the login procedure has been properly executed, the user may decide to search auctions to determine what tickets are for sale or enter the release tickets mode if the user is a ticket holder wanting to release tickets.

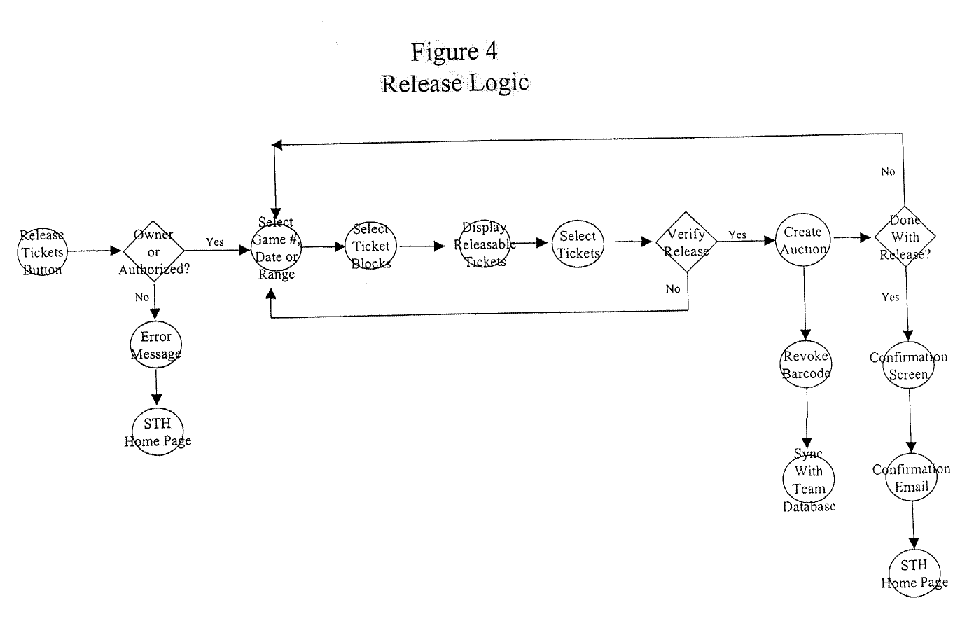

FIG. 4 illustrates the exemplary embodiment in which the original ticket holder logs onto the system and releases tickets for auction. Once the ticket holder has logged onto the system and has been verified, the ticket holder chooses the release tickets button. If the ticket holder is not authorized to release tickets, an error message occurs, and he/she is sent back to the home page. However, if the ticket holder is authorized, the auction engine proceeds to the selection process. First, the ticket holder selects the event and the event date for which the tickets will be auctioned. Then, the ticket holder selects the tickets to be released. Tickets displayed as available for release will be only those tickets controlled by the original ticket holder. For instance, if the ticket holder has four tickets to an event, different permutations of tickets may be released for auction, even though most ticket holders will chose to release an entire block or an even number of tickets within that block. The ticket holder then proceeds through a number of verification screens to ensure that the proper tickets are being released. Once the verification is complete, the auction engine communicates with the barcode issuer/canceler to cancel the barcodes corresponding to the physical barcodes on the released tickets. This prohibits the original ticket holder from releasing tickets for an event and then gaining admittance to the venue with the original tickets. Also, the auction engine 22 communicates with the venue database 18 via the virtual ticket server. Finally, the original ticket holder receives a message confirming which tickets have been released. The ticket holder may exit the system by communicating with the server that he/she is done releasing tickets, the ticket holder may release tickets for other events, or the ticket holder may bid on auctions or purchase available tickets at the instant sales price.

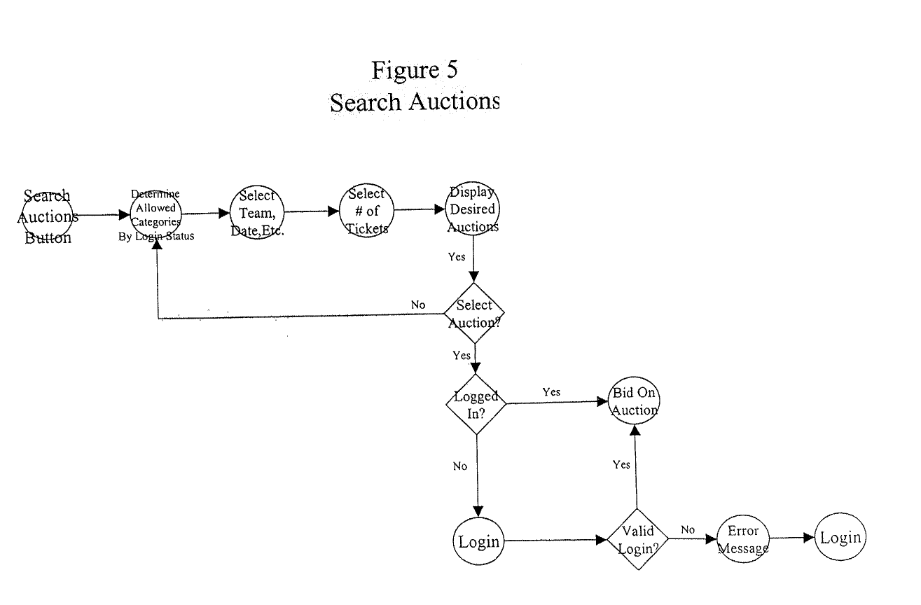

If the user chooses the search auctions mode, the user enters the online auction portion of the present invention via the auction engine 22. As illustrated in FIG. 5, the system first determines the categories or types of auctions the user is authorized to participate (i.e. bid on tickets). Once the system makes this determination, the user is allowed to select among eligible auctions where he/she can submit bids. Once authorized, the user may search auctions based on a variety of categories including, but not limited to, team, date, number of tickets, venue and geographic location (i.e. city). If the user finds an auction that corresponds to his/her ticket criteria, he/she may then select that auction.

Immediately after a user selects an auction, the server 22 performs another login check to make sure the user is logged into the system. If the user has not logged in, he/she is directed to the login screen to complete this process. Once the login is successfully completed, he/she is then transported back to the auction he/she selected. If the user has already logged in, he/she proceeds directly to the bid/buy function.

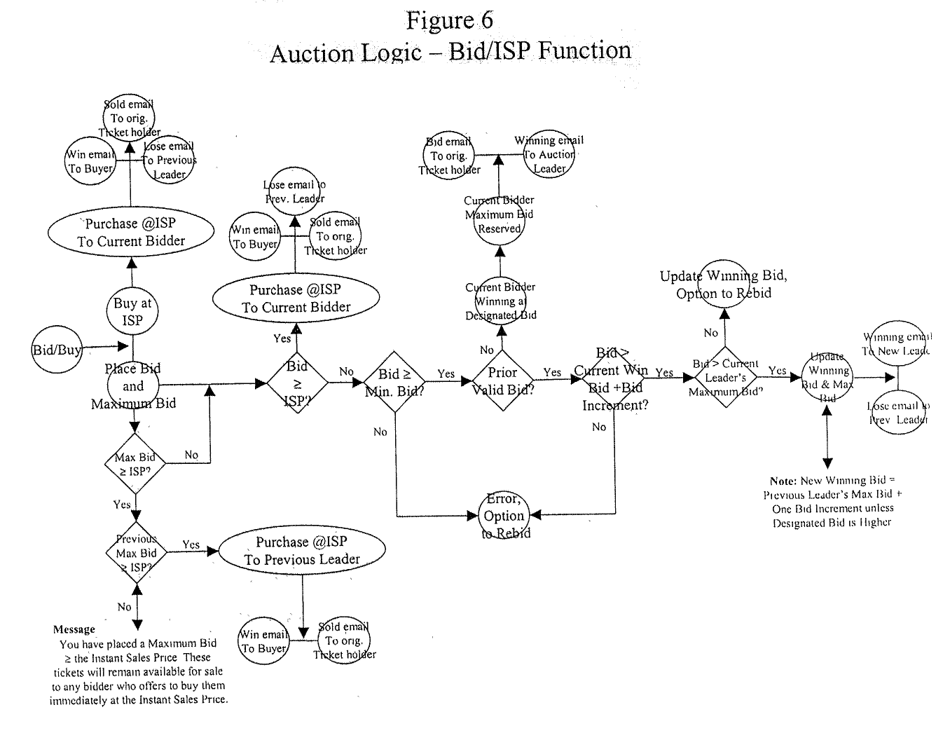

FIG. 6 illustrates the bid/buy function of the present invention. The bidder, who has already properly logged onto the system, may search the pending auctions. Once the bidder finds an auction on which he/she wishes to bid, a bid/buy action may be entered by the bidder. If the bidder initiates a buy transaction, this is an indication that the bidder (now the buyer) is willing to pay the instant sales price (ISP) for the tickets. The buyer confirms his/her billing information and delivery method after which the sale is consummated. A message is then sent to the buyer notifying him/her that he/she has purchased the tickets at the ISP. A message is also sent to the original ticket holder informing him/her that the previously released tickets have been sold. If a prior winning bidder existed for these tickets, he/she is notified that the tickets have been bought at the ISP. The system then proceeds to the barcode canceler/issuer 26 wherein new barcodes are generated for the purchased tickets. Depending upon the delivery method chosen, these tickets can then be printed remotely by the buyer, physically sent to the buyer under several delivery options, or simply held at will call for the buyer to pick up at the venue. The venue's server 16 is also notified of the new barcode. The venue's server 16 updates the new barcode in its database 18. The buyer now has valid barcode tickets for the event.

If a bid transaction is initiated (instead of buying at the ISP), the bidder indicates how much he/she is willing to bid (current bid) for the tickets and may also indicate his/her maximum bid price (max. bid is used by the bidding agent when the bidder is not online). The auction engine 22 compares the current bid against the ISP. If the current bid is greater than or equal to the ISP, the bidder is notified that this bid indicates an intention to purchase the tickets immediately at the ISP. The bidder is then transferred into the ISP purchase protocol to consummate the sale. The bidder (now the buyer), the original ticket holder and the previous winning bidder (if applicable) are all notified as previously indicated when a bidder initiates a buy transaction.

If the current bid is not greater than or equal to the ISP, the system determines if the current bid is greater than or equal to the minimum bid. If the current bid is less than the minimum bid, the bidder is notified that the current bid doe not exceed the minimum bid, and he/she is allowed to re-bid. If the current bid is greater than or equal to the minimum bid, and no prior bid exists, the bidder is notified that he/she has the current winning bid at his/her current bid. If this bidder also entered a maximum bid, and no prior maximum bid exists, this maximum bid is reserved for the bidder. The original ticket holder is notified that a bid has been placed on his/her previously released tickets, and the bidder is notified that his/her bid is currently winning.

If a prior bid exists, the system 10 determines if the current bid is greater than the prior bid plus the bid increment. If not, and the current bidder does not have a maximum bid, the bidder is notified that the current bid did not exceed the prior bid plus the bid increment, and he/she is allowed to re-bid. If the current bid is greater than the prior bid plus the bid increment, the system determines if the current bid is higher than previous leader's maximum bid (if applicable). If so, the current bidder is notified that he/she is winning at his/her current bid. The previous leader is notified that his/her bid is no longer winning. The system 10 then determines if the current bidder has a maximum bid higher than his/her current bid. If so, this maximum bid is reserved for the new winning bidder.

However, if the bidder's current bid is greater than the prior winning bid plus the bid increment but is less than the current leader's maximum bid, the system then determines if the current bidder has a maximum bid. If not, the prior winning bid is updated to reflect the bidder's current bid plus one bid increment, and this new winning bid becomes the previous leader's new winning bid. The current bidder is notified that he/she has not exceeded the current leader's reserved maximum bid, and he/she is given the option to re-bid.

If no previous maximum bid exists, the current bid becomes the current winning bid and the bidder is notified that he/she is the leading bidder. The previous leader is also notified that he/she is no longer winning the auction and may enter a new bid, if so desired.

If the bidder has entered a maximum bid, it is compared against the ISP. If the current bidder's maximum bid is greater than or equal to the ISP, and if the previous leader has a maximum bid also greater than or equal to the ISP, the tickets sell to the previous leader at the ISP. If the previous leader did not have a maximum bid great than or equal to the ISP, the current bidder's maximum bid, if greater than or equal to the ISP, results in a message to the current bidder that these tickets will remain available for purchase by anyone willing to purchase them at the ISP before the auction formally closes.

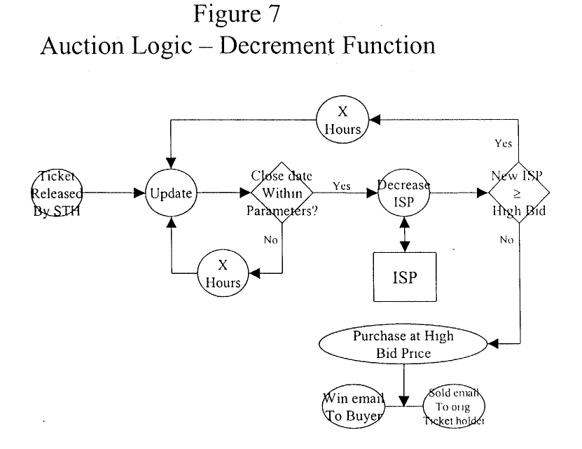

The auction engine 22 of the present invention may also have the added feature of changing or modifying the ISP, if the commencement time of the event is approaching and the released tickets have not yet been sold. As illustrated in FIG. 7, the auction engine 22 includes an auction decrement function. In one embodiment, an update function periodically checks to see if the event date is approaching. At a set time, the update will get a message that the event is still “X” hours from commencement. If, however, the update returns a message that the event is less than “X” hours away from commencement, the auction engine may decrease the ISP.

Once the ISP has been decreased, the auction engine 22 compares the new ISP versus the current high bid. If the current high bid exceeds the now decreased ISP, the bid is accepted, the online credit card transaction occurs and the winner is notified as well as the original ticket holder. If the current high bid does not exceed the new ISP, the auction continues until someone wins. Of course, if at the specified time period, the update function will again decrease the ISP and renew the compare process unless someone has won in the interim.

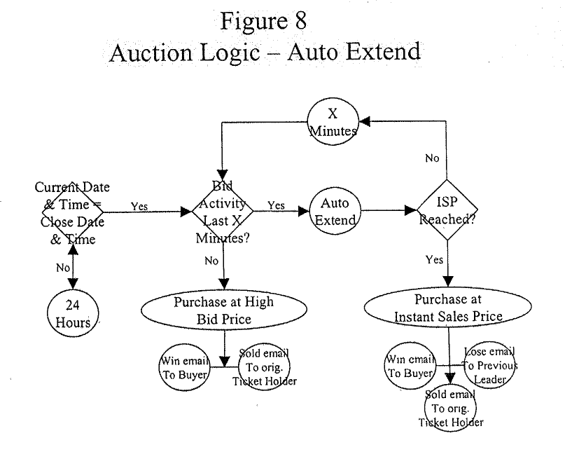

Besides automatically decreasing the ISP as the event time approaches, in one embodiment the invention may automatically extend the auction time. As illustrated in FIG. 8, this logic works similarly to the auto decrease logic.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A system for auctioning, canceling and reissuing a ticket comprising:
a) an auction server;
b) an auction engine in communication with said auction server;
c) a barcode canceler/issuer in communication with said auction engine; and
d) an auction database in communication with said auction engine capable of receiving and transmitting ticket information to the auction engine.

2. The system of claim 1 wherein said auction server is capable of communicating with clients and venues.

3. The system of claim 1 wherein said barcode canceler/issuer may cancel and reissue ticket information.

4. The system of claim 1 wherein said auction engine may conduct online purchasing transactions.

5. The system of claim 1 wherein said ticket information includes barcode information.

6. The system of claim 4 wherein said auction database contains online transaction information.

7. A method for auctioning, canceling and reissuing a ticket comprising:
a) accessing an auction server by a remote client;
b) generating a request for venue information by an auction engine;
c) transmitting said request for venue information from said auction engine to said auction server to a venue server;
b) transmitting venue information from a venue database to an auction database;
c) remote client requesting and releasing a ticket to an auction engine for auction;
d) canceling identification information for a released ticket;
d) conducting an auction for said tickets until a winning bid or a sale at the instant sales price occurs; and
e) reissuing new ticket information for said released tickets; and
f) transmitting said new ticket information to winning remote client and said venue database.

8. The method of claim 7 wherein said step of conducting an auction comprising:
a) setting an instant sale price and an auction expiration time;
b) accepting a first bid including a maximum bid;
c) accepting other incremental and maximum bids; and
d) determining an auction winner at the expiration of said auction expiration time.

9. The method of claim 8 further comprising
a) extending the auction expiration time.

10. The method of claim 8 further comprising:
a) decreasing the instant sales price.

11. The method of claim 8 further comprising:
a) allowing an auction to be won by purchasing at the instant sales price.

12. The method of claim 8 further comprising:
a) notifying a ticket seller that his tickets have been sold.
